(19) United States
(12) Patent Application Publication
(10) Pub. No.: US 2010/0091604 A1
(43) Pub. Date: Apr. 15, 2010

(54) MIXING METHOD

(75) Inventor: Gerald Jesson, Knivsta (SE)

Correspondence Address: FULBRIGHT & JAWORSKI, LLP, 1301 MCKINNEY, SUITE 5100, HOUSTON, TX, 77010-3095, US

(73) Assignee: Gyros Patent AB, Uppsala (SE)

(21) Appl. No.: 12/527,891

(22) PCT Filed: Jan. 30, 2008
(86) PCT No.: PCT/SE2008/050118

§ 371 Date: Dec. 8, 2009

Related U.S. Application Data
(60) Provisional application No. 60/890,686, filed on Feb. 20, 2007.

(30) Foreign Application Priority Data
Feb. 21, 2007 (SE) 0700424 5

(51) Int. Cl. B01F 13/02; B01L 3/00

(52) U.S. Cl. 366/105

(57) ABSTRACT

The present invention includes a method of mixing at least two aliquots in a microchannel structure (140) provided on a rotatable substrate (130) having a rotating centre, comprising the actions of: providing a volume of X of aliquot I into a first inlet microchannel (102), providing a volume of Y of aliquot II into a second inlet microchannel (101), rotating said substrate (130) in order to overcome a first microfluidic valve (104) and to move said aliquots I and II from said first and second inlet microchannels (102, 101) into said mixing chamber (106), where said mixing chamber (106) has a volume larger than X+Y, and shaking said aliquots I and II together with a gas bubble in said mixing chamber (106).

### TECHNICAL FIELD

The present invention relates to an improved method in a microfluidic device, and more particularly to a method of mixing at least two samples in a mixing cavity/chamber of said microfluidic device.

### BACKGROUND OF THE INVENTION

Microchannel or microcavity structures are used inter alia chemical analytical techniques, such as electrophoresis and chromatography. A microfluidic device is defined as a device in which one or more liquid aliquots that contain reactants and have volumes in the μl-range are transported and processed in microchannel structures that have a depth and/or width that are/is in the μm-range. The μl-range is ≦1000 μl, such as ≦25 μl, and includes the nl-range that in turn includes the pl-range. The nl-range is ≦5000 nl, such as ≦1000 nl. The pl-range is ≦5000 pl, such as ≦1000 pl. The μm-range is ≦1000 μm, such as ≦500 μm.

A microfludic device typically contains a plurality of the microchannel structures described above, i.e. has two or more microchannel structures, such as ≧10, e.g. ≧25 or ≧90. The upper limit is typically ≦2000 structures, Microchannel structures coupled together define a microchannel system.

Different principles may be utilized for transporting the liquid within a microchannel structure. Inertia force may be used, for instance by spinning a disc comprising said microchannel structures. Other useful forces are electrokinetic forces and non-electrokinetic forces other than centrifugal force, such as capillary forces, hydrostatic pressure, pressure created by one or more pumps etc.

The microfluidic device typically is in the form of a disc. The preferred formats have an axis of symmetry (Cₙ) that is perpendicular to or coincides with the disc plane, where n is an integer ≧2, 3, 4 or 5, preferably ∞ (C_{∞}). The disc thus may have various polygonal forms such as rectangular. The preferred sizes and/or forms are similar to the conventional CD-format, e.g. sizes in the interval from 10% up to 300% of a circular disc with the conventional CD-radii (12 cm). If the microchannel structures are properly designed and oriented, spinning of the device about a spin axis that typically is perpendicular or parallel to the disc plane may create the necessary centrifugal force for causing parallel liquid transport within the structures. In the most obvious variants at the priority date, the spin axis coincides with the above-mentioned axis of symmetry.

In preferred microchannel structures, capillary force is used for introducing liquid through an inlet port up to a first capillary valve whereafter centrifugal force or some other non-passive driving means is applied for overcoming the resistance for liquid flow at the valve position. The same kind of forces/driving means is also used for overcoming capillary valves at other positions.

The microfluidic device may be circular and of the same dimension as a conventional CD (compact disc).

In order to facilitate efficient transport of liquid between different functional parts, inner surfaces of the parts should be wettable (hydrophilic), i.e. have a water contact angle 90°, preferably 60° such as S 50° or 40° or 30° or 20°. These wettability values apply for at least one, two, three or four of the inner walls of a microconduit. The wettability or hydrophilicity, in particular in inlet arrangements, should be adapted such that an aqueous liquid will be able to fill up an intended microcavity/microconduit by capillarity (self suction) once the liquid has started to enter the cavity/microconduit. A hydrophilic inner surface in a microchannel structure may comprise one or more local hydrophobic surface breaks (water contact angle ≧90°. Such a break may wholly or partly define a passive/capillary valve, an anti-wicking means, a vent to ambient atmosphere etc. Contact angles refer to values at the temperature of use, typically +25° C., and are static. See WO 00056808, WO 01047637 and WO 02074438 (all Gyros AB).

Microchannels/microcavities may be arranged on one side of a substrate and thereafter covered by a lid in order to create a closed microcavity, of course said microcavity and/or said microchannel may be provided with at least one inlet and at least one outlet. Said substrate may be of the same thickness as an ordinary compact disc, i.e., in the range of 1 mm. Said substrate may be regarded as semi flexible, i.e., the disc is bendable but may not change form if it is supported by different topologies.

The lid may be regarded as flexible, i.e., if you put the lid on two different topologies the lid will take two different forms. It is advantageous to use a thicker substrate in which you may define the microchannels and on top of said substrate a flexible lid in form of a film, which may easily adapt itself to any curling and/or unevenness of the substrate that may be present. In this way you may increase the probability of attaching the lid to each and every portion of the substrate that one want to.

During the advent of the microfluidic era, mixing of liquids aliquots in microchannel structures primarily was accomplished by creating turbulence. However, miniaturization led to smaller and smaller cross sectional dimensions rendering mixing by turbulence complicated.

Mixing variants were developed that utilized mixing units that had two inlet microconduits that merged into a mixing microconduit that ended in a microcavity or chamber for collecting the resulting mixed aliquot. Mixing started by introducing separate aliquots that were transported “in parallel” in the inlet microconduits. Downstream the junction of the inlet microconduits, the two aliquots were flowing in a laminar manner in contact with each other. Mixing was accomplished by diffusion between the aliquots, i.e., a slow exchange of molecules.

Enlarging the length of the mixing microconduit may speed up/improve the mixing process, but this is in contrary to the general trend in microfluidic that aims at placing the largest possible number of microchannel structures in the smalles possible area.

Further, there is a need in the art for short mixing times in small microfluidic mixing channels/cavities/chambers. However, decreasing the size of the microfluidic mixing channels/cavities/chambers may cause problems such as clogged mixing channels/cavities/chambers structures due to the increased ratio of inner surface area relative to its volume. Smaller volumes of mixing channels/cavities/chambers also tend to increase the likelihood of diffusion mixing due to laminar flow of the samples in said channels/cavities/chambers.

### SUMMARY OF THE INVENTION

An object of the present invention is to achieve a quick mixing in microfluidic device which requires small space and which further at least reduces the problem with clogged microchannel structures and diffusion type of mixing when mixing two samples in a small mixing channel/cavity/chamber.

The foregoing and other objects, apparent to the skilled man from the present disclosure, are met by the invention as claimed.

In a first example embodiment a method of mixing at least two aliquots in a microchannel structure provided on a rotatable substrate having a rotating centre, comprising the actions of: providing a volume of X of aliquot I into a first inlet microchannel, providing a volume of Y of aliquot II into a second inlet microchannel, rotating said substrate in order to overcome a first microfluidic valve and to move said aliquots I and II from said first and second inlet microchannels into said mixing chamber, where said mixing chamber has a volume larger than X+Y, shaking said aliquots I and II together with a gas bubble in said mixing chamber,

Other aspects of the present invention are reflected in the detailed description, figures and claims.

### BRIEF DESCRIPTION OF THE DRAWINGS

FIG. 1 a depicts a top view of a an example embodiment of a part of a microfluidic device according to the present invention.

FIG. 1b depicts a top view of an example embodiment of a part of a microfluidic device according to the present invention.

FIG. 1c depicts a view from above of an example embodiment of a microfluidic device according to the present invention.

FIG. 1d depicts a view from above of an example embodiment of a microfluidic device according to the present invention.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

At least one of the samples to be mixed shall be in liquid form. One or more samples may be in a solid or semisolid form that is soluble or dispersible (suspensible) in the at least one liquid with which it is to be mixed. In this context solid also include semisolid materials as gels, cells etc that are more or less soft. The mixed product obtained by the innovative mixing is homogenous and in the form of a mixture/solution or a dispersion (suspension).

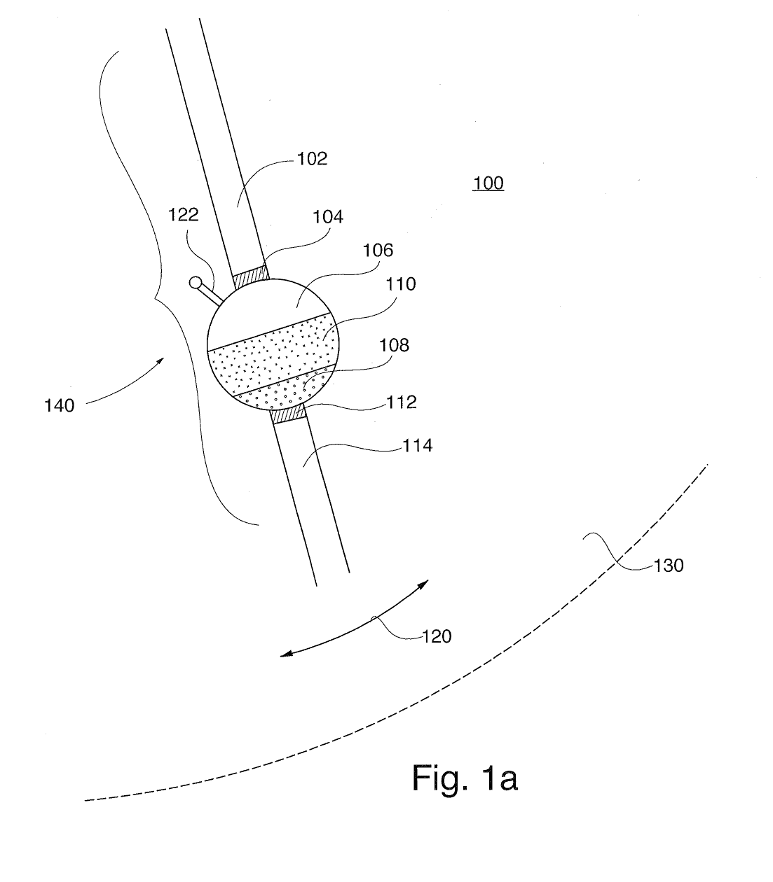

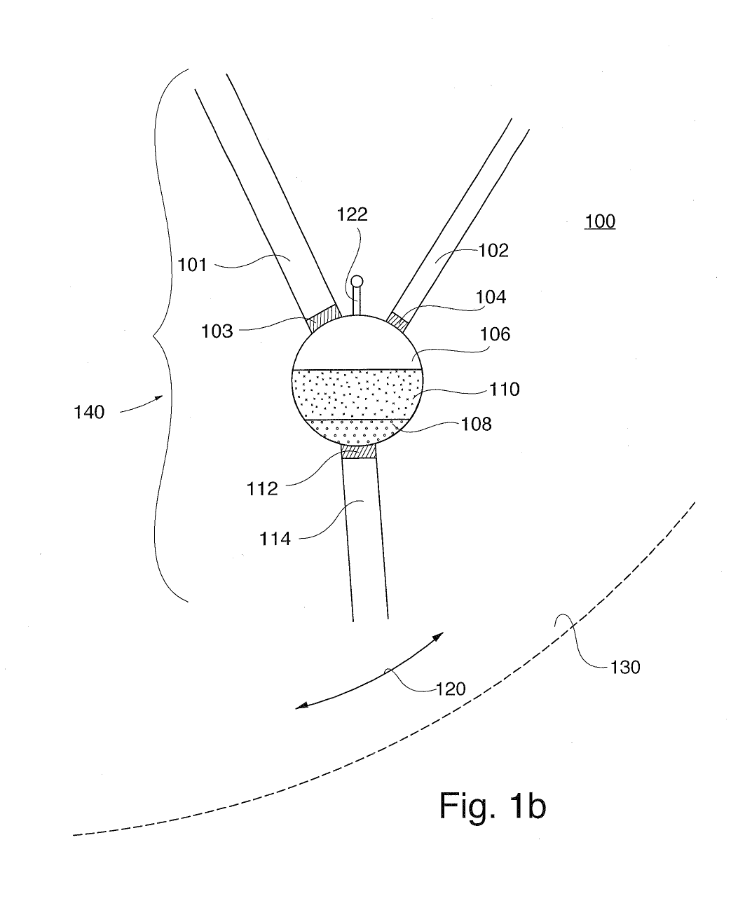

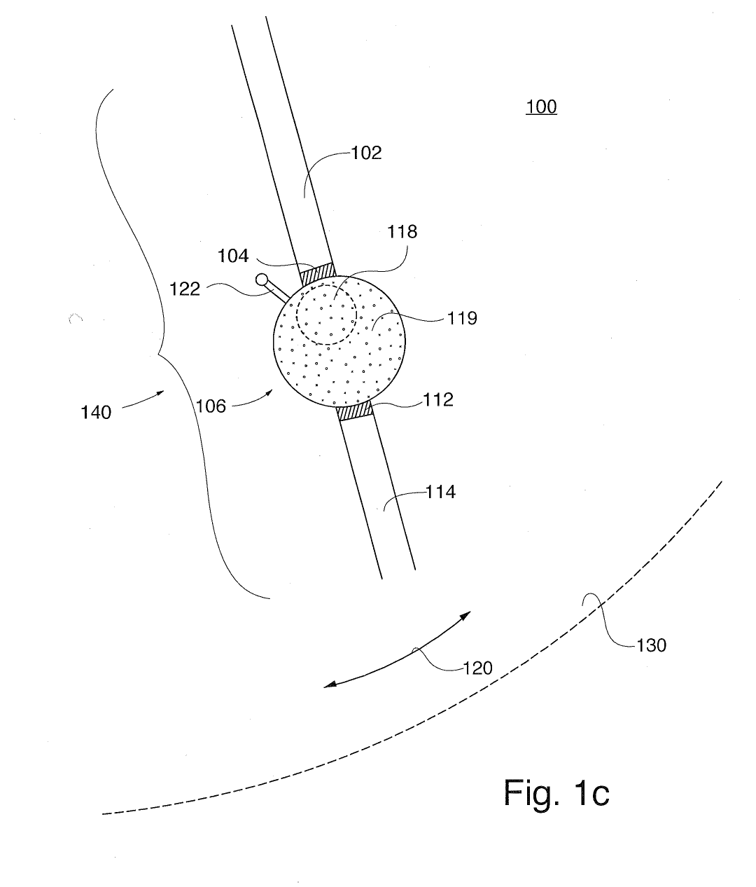

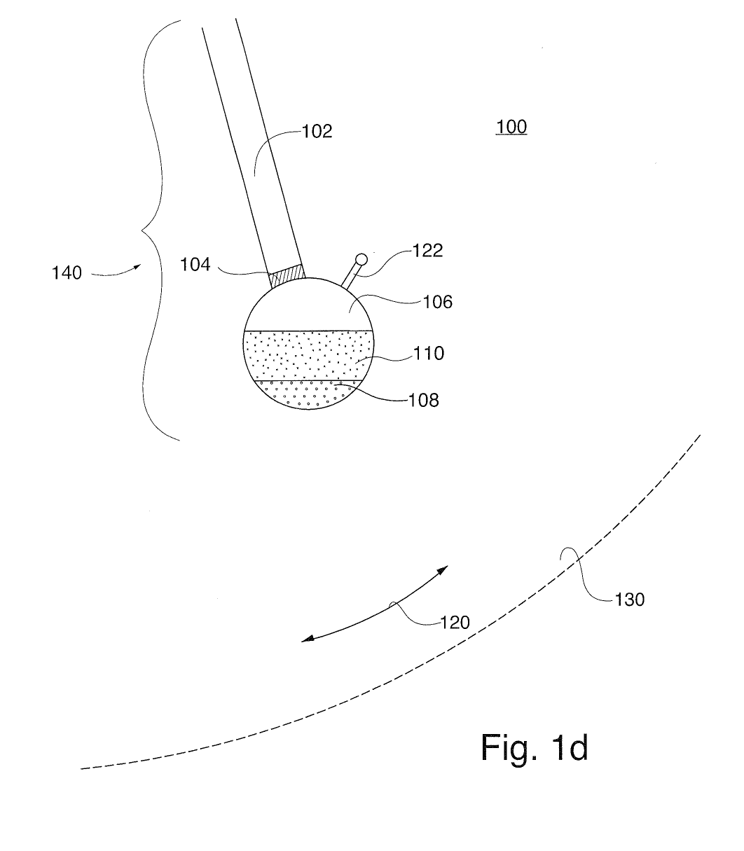

FIGS. 1a and 1b depicts top views of an example embodiment of a part of a microfluidic device 100 according to the present invention. Said device 100 comprises a substrate 130 in which a microfluidic system is provided. Said microfluidic system comprises in turn at least one microchannel structure 140

The substrate may be made from different materials, such as plastics including elastomers, such as rubbers including silicone rubbers (for instance poly dimethyl siloxane) etc (Polymethyl methacrylate) PMMA, polycarbonate and other thermoplastic materials, i.e., plastic material based on monomers which comprises polymerisable carbon-carbon double or triple bonds and saturated branched straight or cyclic alkyl and/or alkynene groups. Typical examples are Zeonex™ and Zeonor™ from Nippon Zeon, Japan.

A lid forming sheet material may be attached to the substrate 130 by means of bonding. Without the lid forming sheet material the at least one microfluidic structure 140 would be open, i.e., exposed to ambient atmosphere. The lid forming sheet material will at least partly cover the at least one microfluidic structure 140 provided on the substrate 130. The bonding material may be part of or separately applied to a surface of said substrate 130 and/or a surface of said lid forming sheet material. The bonding material may be the same plastic material as is present in the substrate 130, provided this plastic material can work as a bonding material. Other useful bonding materials are various kinds of adhesives, which fit to the material in the substrate 130 and the lid forming sheet material and the intended use of the final device. Typical adhesives may be selected amongst melt-adhesives, and curing adhesives etc. Curing adhesives may be thermo-curing, moisture-curing, UV-curing and bi- three- and multi component adhesives.

The bonding material may be applied onto said substrate 130 and/or said lid forming sheet material according to well known methods in the art, such as lamination of the bonding material, screen printing, offset printing, dipping the substrate in the bonding material, spin-application etc.

The lid forming sheet material may be manufactured by the same types of materials as the substrate 130. This material is not critical as long as it is compatible with the adhesive principle etc. However, one may choose one type of material in the substrate 130 to be bonded with another type of material in the lid forming sheet material. The lid forming sheet material may be in the form of a laminated sheet and relatively thin compared to the substrate 130, which substrate 130 comprises the microfluidic structures 140. In one embodiment the thickness of the lid forming material is half a thickness of the substrate 130. In another embodiment the thickness of the lid forming material is ¼ of the thickness of the substrate 130. In yet another embodiment the thickness of the lid forming material is ⅛ of the thickness of the substrate 130. In one embodiment the thickness of the lid forming material is 10% of the thickness of the substrate 130. The lid forming material may have a thickness range of 10 μm-2 mm, more preferably between 20 μm-400 μm. Different thickness ranges may apply to different materials in order to have a semi flexible lid forming sheet material. The substrate 130 may have a thickness range of 100 μm-10 mm, more preferably between 400 μm-2 mm.

The microfluidic structure 140 depicted in FIG. 1a comprises a first inlet microchannel 102, a first hydrophobic break 104, a mixing chamber 106, a second hydrophobic break 112, a first outlet microchannel 114, and an optional air vent 122. A first sample 108 is provided in said first inlet channel. Either the first sample 108 is introduced earlier in a microfluidic system to which said microfluidic structure 140 is part of or introduced via an inlet arranged and coupled directly to said first inlet microchannel 102. Said first sample 108 may be transported into the mixing chamber 106 before, after or together with at least another sample into the first inlet microchannel 102. The first sample, a second sample 110 or the first and the second samples 108, 110 respectively together are introduced into the mixing chamber 106 by breaking the hydrophobic break/valve 104, which may be arranged in the boarder of the first inlet microchannel 102 and the mixing chamber 106. To break the hydrophobic break 106 a pressure may be applied to the sample(s) 108, 110. Said pressure may be in the form of inertia force, for instance by spinning the substrate 130. Other useful forces are electrokinetic forces and non-electrokinetic forces other than centrifugal force, such as capillary forces, hydrostatic pressure, pressure created by one or more pumps etc.

In FIG. 1a, the first sample 108 and the second sample 110 are illustrated to be in a non-mixed form, i.e., the second sample 110 is floating on top of the first sample 108. As illustrated in FIG. 1a, a total volume of the first sample 108 plus the second sample 110 is smaller then the volume of the mixing chamber. In the chamber we therefore have at least two samples, at least one of which must be a fluid, and a certain volume of gas. Said gas may be air, water steam, or any inert gas for instance nitrogen or argon.

The shape of the mixing chamber 106 is in FIG. 1a illustrated to be spherical. However, any for of the mixing chamber may be used such as cubic, tetrahedral, octagonal etc, it is just a matter of complexity in the manufacturing process which may limit the form of such a mixing chamber 106.

The volume of the mixing chamber 106 is adapted to the volumes of the samples to be mixed. A too small mixing chamber 106, i.e., the volume of gas is << than the volume of the first and second samples 108, 110, may decrease the efficiency of the mixing process. In an example embodiment the volume of the first and second samples together is essentially of the same volume of the gas in the mixing chamber. Of course, one may use any volume of gas in the mixing chamber.

In FIG. 1c, it is illustrated in a schematic manner what happens in the mixing chamber 106 when the substrate is starting to oscillate and/or rotate. The mixing chamber 106 in FIG. 1c comprises a mixture of the first sample 108 and the second sample 110 denoted by 119 and a gas bubble 118. The gas bubble greatly affects the mixing of the samples in the mixing chamber 106. There is a tendency of better and quicker mixture of the samples in the mixing chamber 106 the larger the gas bubble 118 is. The bubble 118 permits liquid samples to fully circulate in the mixing chamber 106. If no bubble 118 exists in the mixing chamber 106, the liquids are hindered to fully circulate in the mixing chamber 106.

A repeated spin sequence of +500 rpm in 0.1 sec, −500 rpm in 0.1 sec (repeated 20 times or more) may be used as a permits to obtain a sufficient shaking effect to mix samples in a few seconds. Of course one may spin and or accelerate clockwise (+direction) at a higher or much higher or even lower rpm than the above exemplified 500 rpm. There is no need to use a clockwise rpm, which is identical to the anticlockwise rpm, i.e., +2000 rpm in 0.025 sec may be followed by −1000 rpm in 0.05 sec.

Mixing experiments using sample liquids having different viscosity (e.g., blood plasma and water), demonstrated that one may achieve mixing for a large variety of liquids under 1 seconds if mixed in the mixing chamber together with the bubble 118.

The samples and the bubble are enclosed in the mixing chamber throughout the mixing process, i.e., bubble and samples are retained in mixing chamber and are not transported out of the mixing chamber during mixing.

An inner surface of the mixing chamber 106 may show hydrophilic behavior. On one example embodiment the water contact angle of the inner walls of the mixing chamber 106 is <50°, such as <35°, or <20° or <5°. However larger contact angles may be used such as <90°.

After having mixed at least two samples with each other in the mixing chamber 106, the mixture of the samples may be transported out of the mixing chamber. This may be accomplished by means of rotating the substrate 130 at a sufficiently high speed so that the second hydrophobic break 112 is broken. This second hydrophobic break 112 may be arranged at the boarder of the mixing chamber and the first outlet microchannel 114. The mixture of the samples are transported in the first outlet microchannel 114 after having passed the second hydrophobic break 112.

In FIGS. 1a, 1b and 1c, the first inlet microchannel 102 may be arranged closer to a inner radius/rotating center of the substrate 130 than the first outlet microchannel 114.

The volume of the mixing chamber may be as large as 25000 nl, however, volumes like <1000 nl, such as <500 nl, <100 nl or <50 nl is also applicable.

In FIG. 1b it is illustrated an alternative embodiment of a microchannel structure in which mixing may take place. The only difference between the embodiment illustrated in FIG. 1b and the above mentioned embodiment illustrated in FIG. 1a, is that in FIG. 1b the microchannel structure 140 has two inlets microchannels, a first inlet microchannel 102 and a second inlet microchannel 101. In the embodiment in FIG. 1b, at least a first sample 108 may be provided into the mixing chamber 106 via the first inlet microchannel 102 and at least a second sample may be provided into the mixing chamber 106 via the second inlet microchannel 101. The first and the second inlet microchannels 102, 101 respectively, both have a hydrophobic break 104, 103 which may, as depicted in FIG. 1b, be provided in the boarder of the mixing chamber 106 and the first anlet microchannel and the second inlet microchannel 102, 101 respectively.

The shape of the microfluidic device 100 is according to the example embodiments circular. However, any suitable form of said microfluidic device 100 may be used, such as triangular, rectangular, octagonal, or polygonal.

The liquid flow may be driven by capillary forces, and/or centripetal force, pressure differences applied externally over a microchannel structure and also by other non-electrokinetic forces that are externally applied and cause transport of the liquid. Also electroendosmosis may be utilized for creating the liquid flow.

In the round form, the microfluidic structures 140 may be arranged radially with an intended flow direction from an inner application area radially towards the periphery of the disc. In this variant, the most practical way of driving the flow is by capillary action, centripetal force (spinning the disc).

The size of the disc may be the same as an ordinary CD, although larger or smaller sizes may be used.

The illustrated microfluidic structure 140 may be part of a larger microfluidic system. The microfluidic structure may be place in the beginning, mid section or the end of such a microfluidic system depending on the functionality and/or characteristic of the microfluidic device, i.e., what purpose the microfluidic device is aimed for. Microchannels within the microfluidic system may have different sections with different characteristics such as hydrophobicity and hydrophilicity and different applications such as metering, volume defining sections, affinity binding sections and detections areas etc well known in the art.

A width and depth of microchannels and microcavities in the microfluidic structure and microfluidic system may vary along its length. At least one microchannel may have a depth and/or width, which lie within the range of 10-2000 μm.

In FIG. 1d it is illustrated an alternative embodiment of a microchannel structure in which mixing may take place. The only difference between the embodiment illustrated in FIG. 1d and the embodiment illustrated in FIG. 1a, is that in FIG. 1d the microchannel structure 140 has no outlet microchannel. The embodiment depicted in FIG. 1d comprises an inlet microchannel 102, a hydrophobic break 104 an air vent 122, and a mixing chamber 106. The microchannel structure is provided on a substrate 130. In the embodiment in FIG. 1d, at least a first sample 108 may be provided into the mixing chamber 106 via the inlet microchannel 102 and at least a second sample may be provided into the mixing chamber 106 via the same inlet microchannel 102. The inlet microchannel 102 may have a hydrophobic break, which may, as depicted in FIG. 1d, be provided in the boarder of the mixing chamber 106 and the microchannel 102. In an alternative example embodiment one may use two or more inlet microchannels instead of the single microchannel depicted in FIG. 1d. The air vent is used to allow air to escape from the mixing chamber during for instance filling process. The air vent is provided in a way so that liquid is not able to escape from the mixing chamber, e.g., the air vent may be provided with a hydrophobic inner surface.

The shape of the microfluidic device 100 is according to the example embodiments circular. However, any suitable form of said microfluidic device 100 may be used, such as triangular, rectangular, octagonal, or polygonal.

The liquid flow may be driven by capillary forces, and/or centripetal force, pressure differences applied externally over a microchannel structure and also by other non-electrokinetic forces that are externally applied and cause transport of the liquid. Also electroendosmosis may be utilized for creating the liquid flow.

In the round form, the microfluidic structures 140 may be arranged radially with an intended flow direction from an inner application area radially towards the periphery of the disc. In this variant, the most practical way of driving the flow is by capillary action, centripetal force (spinning the disc).

The size of the disc may be the same as an ordinary CD, although larger or smaller sizes may be used.

The illustrated microfluidic structure 140 may be part of a larger microfluidic system. The microfluidic structure may be place in the beginning, mid section or the end of such a microfluidic system depending on the functionality and/or characteristic of the microfluidic device, i.e., what purpose the microfluidic device is aimed for. Microchannels within the microfluidic system may have different sections with different characteristics such as hydrophobicity and hydrophilicity and different applications such as metering, volume defining sections, affinity binding sections and detections areas etc well known in the art.

A width and depth of microchannels and microcavities in the microfluidic structure and microfluidic system may vary along its length. At least one microchannel may have a depth and/or width, which lie within the range of 10-2000 μm.

The microfluidic device 100 is, as depicted in FIGS. 1a and 1b, circular and adapted for rotation about a central hole, not illustrated. Fluid inlets may in this embodiment be arranged towards the central hole of the device 100. A fluid reservoir may be arranged towards the circumference of the device 100. Microchannels may be of suitable dimensions to enable capillary forces to act upon the fluid within the channel.

Hydrophobic valves/barriers may be arranged in one or a plurality of the microchannels. Fluid may be fed into the inlet and will then be sucked down the channel by capillary action until it reaches the valve, past which it cannot flow until further energy is applied. This energy may for instance be provided by centrifugal force created by rotating the microfluidic device 100.

When RPM (Revolution Per Minute) of the microfluidic device 100 is increased the pressure of the fluid acting upon surfaces of the second fluid cavity is increased. At a certain RPM the pressure may be high enough for breaking the bonding of the lid forming sheet material to the substrate and thereby causing a leakage 414 from said second fluid cavity to said first fluid reservoir 410. Typical RPM ranges is 0-8000 RPM but higher RPM may be used such as 10 000, 15 000 or 20 000.

The microchannels and microcavities may be manufactures according to well known methods in the art, for instance according to a method which is illustrated in EP 1121234.

While the present invention is disclosed by reference to the preferred embodiments and examples detailed above, it is understood that these examples are intended in an illustrative rather than in a limiting sense. It is contemplated that modifications and combinations will readily occur to those skilled in the art, which modifications and combinations will be within the scope of the following claims.

1. A method of mixing at least two aliquots in a microchannel structure provided on a rotatable substrate having a rotating centre, comprising the actions of:
a. providing a volume of X of aliquot I into a first inlet microchannel,
b. providing a volume of Y of aliquot II into a second inlet microchannel,
c. rotating said substrate in order to overcome a first microfluidic valve and to move said aliquots I and II from said first and second inlet microchannels into said mixing chamber, where said mixing chamber has a volume larger than X+Y, and
d. shaking said aliquots I and II together with a gas bubble in said mixing chamber.

2. The method according to claim 1, wherein said first and second inlet microchannels are one single inlet microchannel.

3. The method according to claim 2, wherein said shaking is accomplished by means of repeatedly starting and stopping rotation of said microfluidic.

4. The method according to claim 3, wherein said shaking comprises at least one partial revolution clockwise and at least one partial revolution counterclockwise.

5. The method according to claim 1, wherein said mixing chamber comprises a first outlet microchannel provided with a second microfluidic valve, and wherein during said shaking said second microfluidic valve remains closed.

6. The method according to claim 1 or 5, further comprising the actions of:
defining said volume X of said aliquot I in a volume defining chamber provided in said substrate,
defining said volume Y of said aliquot II in a volume defining chamber provided in said substrate.

7. The method according to claim 5, further comprising the actions of:
rotating said substrate in order to overcome said second microfluidic valve for moving a mixture of aliquot I and aliquot II out of said mixing chamber and into said first outlet microchannel, wherein said first outlet microchannel is provided at a larger distance from said rotating centre than said first and second inlet microchannels.

8. The method according to claim 1, wherein aliquot I and aliquot II are enclosed in the mixing chamber when mixing said aliquots.
